(19) United States
(12) Patent Application Publication
(10) Pub. No.: US 2016/0169701 A1
(43) Pub. Date: Jun. 16, 2016

(54) AUDIO VIDEO NAVIGATION DEVICE, VEHICLE HAVING THE SAME AND METHOD FOR CONTROLLING THE VEHICLE

(71) Applicant: HYUNDAI MOTOR COMPANY, Seoul (KR)

(72) Inventors: WonSeok Yang, Ansan (KR); Hongjun Kim, Anyang (KR); Mukyung Jung, Suwon (KR)

(21) Appl. No.: 14/876,903

(22) Filed: Oct. 7, 2015

(30) Foreign Application Priority Data
Dec. 11, 2014 (KR) 10-2014-0178246

(51) Int. Cl. G01C 21/36; G01S 19/42; G01S 19/40

(52) U.S. Cl. CPC G01C 21/3676; G01S 19/40; G01S 19/42

(57) ABSTRACT

An Audio-Video-Navigation (AVN) device includes: a Global Positioning System (GPS) receiver obtaining a traveling route data of a vehicle; a storage storing information about a navigation map; a navigation controller capturing a navigation map screen of the navigation map; and a application controller displaying a traveling route of the vehicle, based on the traveling route data, on the captured navigation map screen and executing an application to provide the navigation map screen on a display. The navigation controller captures the navigation map screen in response to a request of the application controller.

### CROSS-REFERENCE TO RELATED APPLICATION

This application claims the benefit of and priority to under 35 U.S.C. §119(a) a Korean patent application filed on Dec. 11, 2014 in the Korean Intellectual Property Office and assigned Serial No. 10-2014-0178246, the entire disclosure of which is incorporated herein by reference.

### TECHNICAL FIELD

The present disclosure relates to an Audio-Video-Navigation (AVN) device, a vehicle having the same, and a method for controlling the vehicle, which presents a traveling route of the vehicle.

### BACKGROUND

Many recently developed vehicles have built-in Audio-Video-Navigation (AVN) devices. An AVN device may present the user a route to a destination and display various control screens to control other devices equipped in the vehicle, as well as screens related to additional functions that may be executed in the navigation terminal. Accordingly, research is ongoing in order to find techniques for efficiently presenting information to the user.

### SUMMARY

The present disclosure provides an Audio-Video-Navigation (AVN) device, a vehicle having the same, and a method for controlling the vehicle, which presents a traveling route of the vehicle based on map information contained in the AVN device.

In accordance with embodiments of the present disclosure, an Audio-Video-Navigation (AVN) device is provided. The AVN device includes: a Global Positioning System (GPS) receiver obtaining traveling route data of a vehicle; a storage storing information about a navigation map; a navigation controller capturing a navigation map screen of the navigation map; and an application controller displaying a traveling route of the vehicle, based on the traveling route data, on the captured navigation map screen and executing an application to provide the navigation map screen on a display, wherein the navigation controller captures the navigation map screen in response to a request of the application controller.

The GPS receiver may be configured to obtain GPS coordinates of the traveling route, and the navigation controller may be configured to generate corrected GPS coordinates by matching the GPS coordinates with the information about the navigation map.

The navigation controller may be configured to generate the corrected GPS coordinates by further matching the GPS coordinates with information about roads on the navigation map.

The application controller may be configured to display the corrected GPS coordinates on the captured navigation map screen.

The application controller may be configured to determine center coordinates of the traveling route and a reduced scale level of the navigation map, based on the traveling route data.

The navigation controller may be configured to receive the center coordinates and the reduced scale level from the application controller and capture the navigation map screen based on the received center coordinates and reduced scale level.

Furthermore, in accordance with embodiments of the present disclosure, a vehicle is provided. The vehicle includes: a Global Positioning System (GPS) receiver obtaining a traveling route data of a vehicle; a storage storing information about a navigation map; a navigation controller capturing a navigation map screen of the navigation map; and an application controller displaying a traveling route of the vehicle, based on the traveling route data, on the captured navigation map screen and executing an application to provide the navigation map screen on a display, wherein the navigation controller captures the navigation map screen in response to a request of the application controller.

The GPS receiver may be configured to obtain GPS coordinates of the traveling route, and the navigation controller may be configured to generate corrected GPS coordinates by matching the GPS coordinates with the information about the navigation map.

The navigation controller may be configured to generate the corrected GPS coordinates by further matching the GPS coordinates with information about roads on the navigation map.

The application controller may be configured to display the corrected GPS coordinates on the captured navigation map screen.

The application controller may be configured to determine center coordinates of the traveling route and a reduced scale level of the navigation map, based on the traveling route data.

The navigation controller may be configured to receive the center coordinates and the reduced scale level from the application controller and capture the navigation map screen based on the received center coordinates and reduced scale level.

Furthermore, in accordance with embodiments of the present disclosure, a method for controlling a vehicle is provided. The method includes collecting traveling route data of a vehicle; determining center coordinates of a traveling route of the vehicle and a reduced scale level of a navigation map, based on the traveling route data; capturing a navigation map screen of the navigation map based on the center coordinates and the reduced scale level; and displaying the traveling route on the captured navigation map screen.

Collecting the traveling route data may include obtaining Global Positioning System (GPS) coordinates of the traveling route.

The method may further include generating corrected GPS coordinates by matching the GPS coordinates with a pre-stored navigation map.

The method may further include generating the corrected GPS coordinates by further matching the GPS coordinates with roads on the navigation map.

Displaying the traveling route may include displaying the corrected GPS coordinates on the captured navigation map screen.

Other aspects, advantages, and salient features of the disclosure will become apparent to those skilled in the art from the following detailed description, which, taken in conjunction with the accompanying drawings, discloses embodiments of the disclosure

### BRIEF DESCRIPTION OF THE DRAWINGS

The above and other features and advantages of the present disclosure will become more apparent by describing in detail embodiments thereof with reference to the attached drawings in which:

FIG. 1 illustrates an interior of a vehicle, according to an embodiment of the present disclosure;

FIG. 2 illustrates an interior of a vehicle, according to embodiments of the present disclosure;

FIG. 3 is a control block diagram of an Audio Video Navigation (AVN) device, according to embodiments of the present disclosure;

FIG. 4 illustrates Global Positioning System (GPS) coordinates of a vehicle matched on a road area of a navigation map;

FIG. 5 illustrates corrected GPS coordinates;

FIG. 6 illustrates a captured screen of a navigation map;

FIGS. 7 and 8 illustrate navigation map screens presented on a display, which display the vehicle's traveling route;

FIG. 9 is a flowchart illustrating a method for controlling a vehicle, according to embodiments of the present disclosure; and

FIG. 10 is a flowchart illustrating a method for controlling a vehicle, according to embodiments of the present disclosure.

Throughout the drawings, like reference numerals will be understood to refer to like parts, components, and structures.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Embodiments of an Audio-Video-Navigation (AVN) device, a vehicle having the same, and a method for controlling the vehicle will now be described in detail with reference to accompanying drawings.

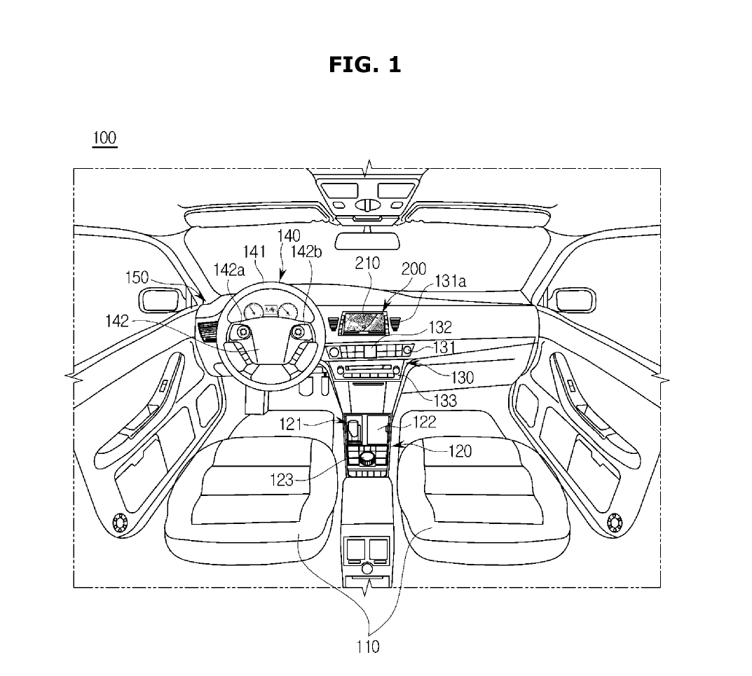

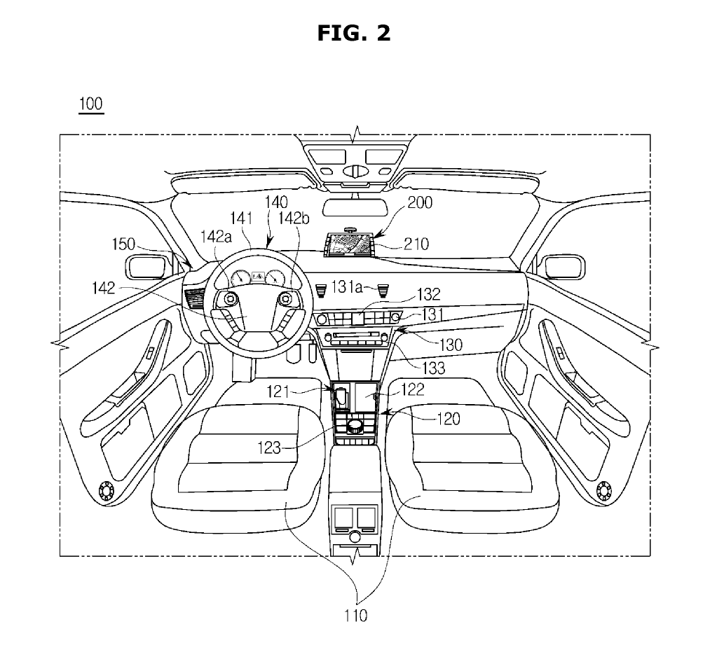

FIG. 1 illustrates an interior of a vehicle 100, according to embodiments of the present disclosure, and FIG. 2 illustrates an interior of the vehicle 100, according to embodiments of the present disclosure.

As shown in FIGS. 1 and 2, the vehicle 100 may include seats 110 reserved for driver and passenger to sit on, a gear box 120, a center facia 130 (i.e., console) and a dashboard 150 having a steering wheel 140.

In the gear box 120, a gearshift 121 for shifting gears of the vehicle 100, and a touch pad 122 for controlling functions of the vehicle 100 may be installed. A dial adjuster 123 may be optionally installed as needed.

In the center facia 130, an air conditioner 131, a clock 132, an audio system 133, and the like may be installed. Further, an AVN device 200 may be installed therein. The air conditioner 131 keeps the atmosphere inside the vehicle 100 comfortable by controlling temperature, humidity, air cleanness, and air flow of the inside of the vehicle 100. The air conditioner 131 may include at least one vent 131a installed in the center facia 130 for venting air. There may also be buttons or dials installed in the center facia 130 to control e.g., the air conditioner 131. The driver or the user may control the air conditioner 131 with the buttons arranged on the center facia 130. The clock 132 may be mounted around the buttons or dials for controlling the air conditioner 131. The audio system 133 may include a control panel on which a number of buttons are mounted to perform functionality of the audio system 133. The audio system 133 may provide a radio mode for presenting a radio listening function and a media mode for reproducing audio files stored in various storage media.

The AVN device 200 is a device for comprehensively performing audio, video and navigation functions of the vehicle 100. For instance, the AVN device 200 may provide a radio service for tuning in to a radio program based on terrestrial radio signals, an audio service for playing e.g., Compact Disks (CDs), a video service for playing e.g., Digital Versatile Disks (DVDs), a navigation service for performing route guidance, a telephone service for controlling incoming calls to a mobile terminal connected with the vehicle 100, etc. The AVN device 200 may selectively display at least one of an audio screen, a video screen, and a navigation screen on a display 230. For example, the AVN device 200 may display a screen of an application downloaded by the AVN device 200 on the display 230, which will be described later on. The AVN device 200 may be provided in the form of being concealed around the center facia 130 in the vehicle as shown in FIG. 1, or may be movably or detachably mounted as shown in FIG. 2.

As is known in the art, the steering wheel 140 is a device for controlling a traveling direction of the vehicle 100, including a rim 141 to be held by the driver and a spoke 142 connected to a steering system of the vehicle 100 for connecting the rim 141 to a hub of a shaft for steering. As an example, the control devices 142a, 142b may be formed on the spoke 142 to control various devices, e.g., the audio system. In embodiments, the dashboard 150 may further include various instrument panels to indicate traveling speeds of the vehicle 100, engine rpm, fuel gauge, or the like, and a glove box for containing things.

The vehicle 100 may provide added user convenience by running (i.e., executing) an application stored in the AVN device 200. Among a number of applications, a navigation application, for example, may present a navigation map screen through the display 230 of the AVN device 200 to display a traveling route of the vehicle 100. More specifically, the navigation application may monitor the traveling route of the vehicle 100 according to the user's intention, and present the navigation map screen to display the traveling route of the vehicle 100.

In the present disclosure, techniques are provided for monitoring a traveling route of the vehicle 100 and displaying the traveling route on a navigation map screen with the navigation application stored in the AVN device 200. With the technology to display the traveling route of the vehicle 100 using navigation map information stored in the AVN device 200, time and amount of information to be spent on displaying the traveling route of the vehicle 100 and communications fees charged for downloading a navigation map from a server may be reduced because the traveling route of the vehicle 100 is displayed directly by the application.

The AVN device 200 and the vehicle 100 having the AVN device 200 will now be described in more detail.

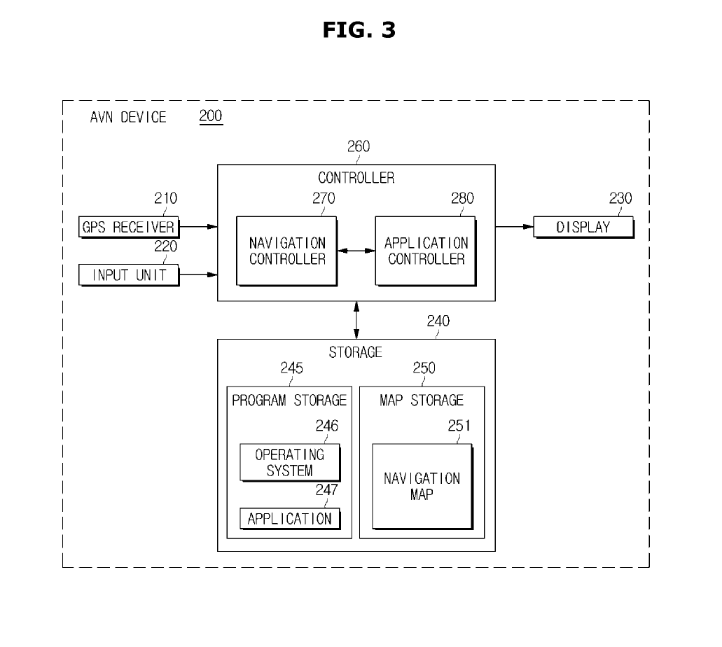

FIG. 3 is a control block diagram of the AVN device 200, according to embodiments of the present disclosure. The vehicle 100 may include the AVN device 200 as shown in FIG. 3, and the description of the AVN device 200 may include some description of the vehicle 100.

As shown in FIG. 3, the AVN device 200 in accordance with an embodiment may include a Global Positioning System (GPS) receiver 210, an input unit 220, the display 230, a storage 240, and a controller 260. The components shown in FIG. 3 may be implemented in hardware, software, or a combination thereof.

The GPS receiver 210 may process satellite signals received at certain intervals from GPS satellites. In an embodiment, the GPS receiver 210 may obtain traveling route data of the vehicle 100 by processing the satellite signals received at certain intervals. The traveling route data may have the form of coordinates, and the GPS receiver 210 may send the GPS coordinates of the vehicle to the controller 260. For example, the GPS receiver 210 may include, but not exclusively, a GPS receive antenna, a satellite signal processor, and the like.

The input unit 220 may receive a user's command with respect to the AVN device 200. The input unit 220 may, but not exclusively, employ a pressure-type switch or a touch pad.

The display 230 may display various control screens related to controlling the AVN device 200, and screens related to additional functions that may be performed by the AVN device 200. For example, the display 230 may display an application running screen. More specifically, the display 230 may provide a navigation map screen on which a traveling route of the vehicle 100 is displayed. The display 230 may be implemented with Liquid Crystal Displays (LCDs), Light Emitting Diodes (LEDs), Plasma Display Panels (PDPs), Organic Light Emitting Diodes (OLEDs), Cathode Ray Tubes (CRTs), or the like. Furthermore, it may be implemented in the same hardware as the input unit 220 by using an interactive display, such as a touch screen panel.

The storage 240 may include a program storage 245 that stores a program for functions of the AVN device 200, and a map storage 250 that stores data resulting from use of the AVN device 200, e.g., a navigation map. The program storage 245 may store an operating system 246 for driving and controlling the AVN device 200 under control of the controller 260, and applications 247 for providing various additional functions for the AVN device 200. For example, the program storage 245 may store a control program to control the AVN device 200, a dedicated application provided for the first time from the manufacturer or a general application downloaded from the outside, User Interfaces associated with applications, objects for providing the UIs (e.g., images, text, icons, buttons, etc.), databases or associated data, or the like. The map storage 250 may store information regarding a navigation map 251, which may be periodically updated as needed. The information regarding the navigation map 251 may include landform information (e.g., whether it is underground or tunnel), route information (e.g., locations of speed cameras, crossroads, whether it is a highway or not), traffic information (e.g., real-time traffic conditions), location information (e.g., locations of restaurants, gas stations, etc.). The storage 240 may be implemented with a Read Only Memory (ROM) for storing a control program to control the AVN device 200, a Random Access Memory (RAM) or a memory card (e.g., a micro Secure Digital (SD) card, a Universal Serial Bus (USB) memory, etc.) used as a storage section for various tasks performed by the AVN device 200. The storage 240 may also include a non-volatile memory, a volatile memory, a Hard Disc Drive (HDD), a Solid State Drive (SSD), or the like.

The storage 240 may also include a communication module, a touch processing module, a graphic module, a power module, or an associated database. These modules may be implemented in software to perform communication control, touch processing, graphic processing, power control functions, etc. Although the storage 240 is shown as being separated from the controller 260, the storage 240 may also be implemented within the controller 260. In the latter case, the storage unit 240 may be implemented on a board or in a device by being combined with components that constitute the controller 260.

The controller 260 may control signal flows among the components of the AVN device 200 and process data. Furthermore, the controller 260 may run (i.e., execute) the operating system 246 and various applications 247 stored in the storage 240. The controller 260 may include a navigation controller 270 and an application controller 280. The navigation controller 270 may control operation of navigation of the AVN device 200, and the application controller 280 may control operation of applications installed in the AVN device 200.

In embodiments of the present disclosure, a navigation application is configured to request information about a navigation map from the navigation controller 270 and display a traveling route of the vehicle 100 on the received navigation map. In this regard, the application controller 280 may request information about the navigation map from the navigation controller 270 and provide a service to display a traveling route of the vehicle 100 on the screen of the received navigation map.

Signal exchanges between the navigation controller 270 and the application controller 280 will be described below in more detail.

GPS coordinates of the vehicle 100 obtained by the GPS receiver 210 may be delivered to the navigation controller 270. The navigation controller 270 may send the GPS coordinates of the vehicle 100 received from the GPS receiver 210 to the application controller 280. The navigation controller 270 may correct the GPS coordinates of the vehicle 100 and send the corrected GPS coordinates to the application controller 280. Specifically, the navigation controller 270 may generate the corrected GPS coordinates by matching the GPS coordinates of the vehicle 100 with the information about the navigation map, and send the corrected GPS coordinates to the application controller 280. The procedure of generating the corrected GPS coordinates by matching the GPS coordinates of the vehicle 100 with the information about the navigation map may also include generating the corrected GPS coordinates by further matching the GPS coordinates of the vehicle 100 with information about roads on the navigation map.

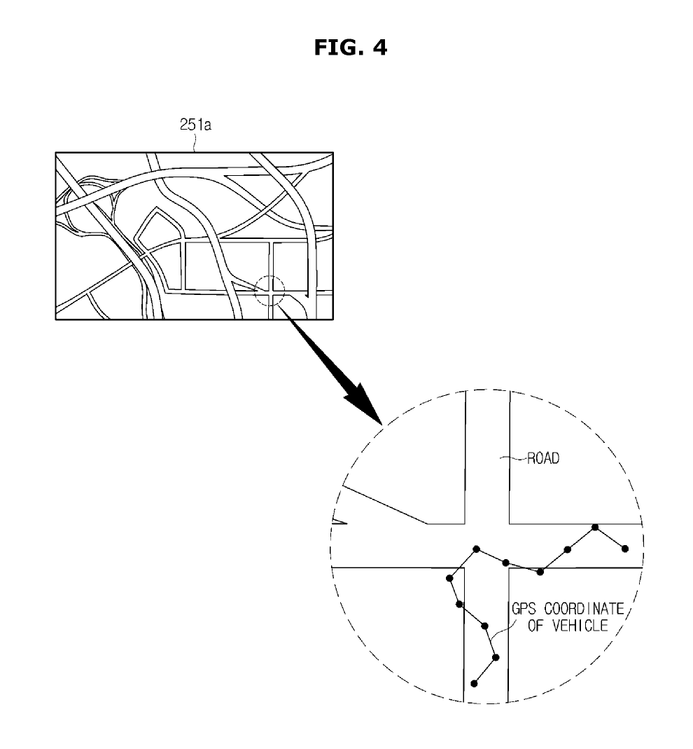

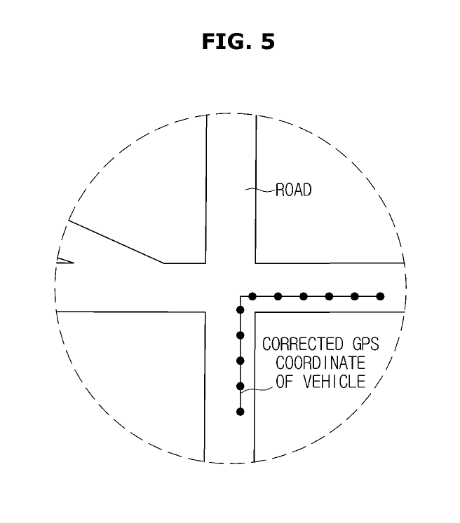

FIG. 4 illustrates GPS coordinates of the vehicle 100 matched on a road area of a navigation map, and FIG. 5 illustrates corrected GPS coordinates matched on the road area of the navigation map.

GPS coordinates of the vehicle 100 may typically have a certain margin of error due to errors in reception of the GPS signals or errors in calculation processes. Accordingly, the coordinates of the traveling route of the vehicle 100 may be matched on the road area, and sometimes matched on somewhere other than the road, e.g., river, lake, field, sidewalk, etc. FIG. 4 shows an occasion where the GPS coordinates of the vehicle 100 are matched on somewhere other than the road. In the case the GPS coordinates are matched on a place other than the road, as shown in FIG. 4, information about a traveling route of the vehicle 100, which is different from actual one, might be provided for the user.

Thus, the navigation controller 270 may correct the traveling route of the vehicle 270. The navigation controller 270 may correct the traveling route of the vehicle 100 by taking into account the form of the road, a past traveling route, traveling pattern, etc., of the vehicle 100. The corrected GPS coordinates of the vehicle 100 may be displayed as shown in FIG. 5, and sent to the application controller 280.

Operation of the application controller 280 after the navigation controller 270 corrects the GPS coordinates of the vehicle 100 and sends the corrected GPS coordinates to the application controller 280 will now be described.

Upon reception of the corrected GPS coordinates from the navigation controller 270, the application controller 280 may store the corrected GPS coordinates in a RAM of the storage 240. Furthermore, the application controller 280 may determine center coordinates of the traveling route of the vehicle 100 (hereinafter, referred to as “center coordinates”) and a reduced scale level of the navigation map (hereinafter, referred to as “reduced scale level”) based on the traveling route data, more specifically, information about the corrected GPS coordinates.

In embodiments of the present disclosure, the way to determine the center coordinates and the reduced scale level may be expressed in the following equations 1 to 4. Equations 1 to 4 are merely examples of determining the center coordinates and the reduced scale level, and the way to determine the center coordinates and the reduced scale level is not limited thereto.

First, the center coordinates may be determined in the following equations 1 and 2:

Latitudinal Center Coordinate=(Latitudinal Minimum Value+Latitudinal Maximum Value)/2 (1)

Longitudinal Center Coordinate=(Longitudinal Minimum Value+Longitudinal Maximum Value)/2 (2)

Next, the reduced scale level may be determined in the following equations 3 and 4:

Scaled Distance 1=sin(90°−Latitudinal Center Coordinate Value)×40,120 km/360°×|Longitudinal Maximum Value−Longitudinal Minimum Value|/Horizontal Length of Display (cm) (3)

Scaled Distance 2=40,120 km/360°×|Latitudinal Maximum Value−Latitudinal Minimum Value|/Vertical Length of Display (cm) (4)

The reduced scale level of equations 3 and 4 is determined based on assumption that the earth is in the form of a perfect sphere.

Once the center coordinates and the reduced scale level are determined as described above, the application controller 280 may send information regarding the center coordinates and reduced scale level and resolution in width and height (in pixel units) of the display 230 to the navigation controller 270 and request the navigation controller 270 for information about a navigation map.

Requested for the information about a navigation map from the application controller 280, the navigation controller 270 may use the information about the center coordinates and reduced scale level, and the resolution in width and height of the display 230 in pixel units to capture a navigation map screen.

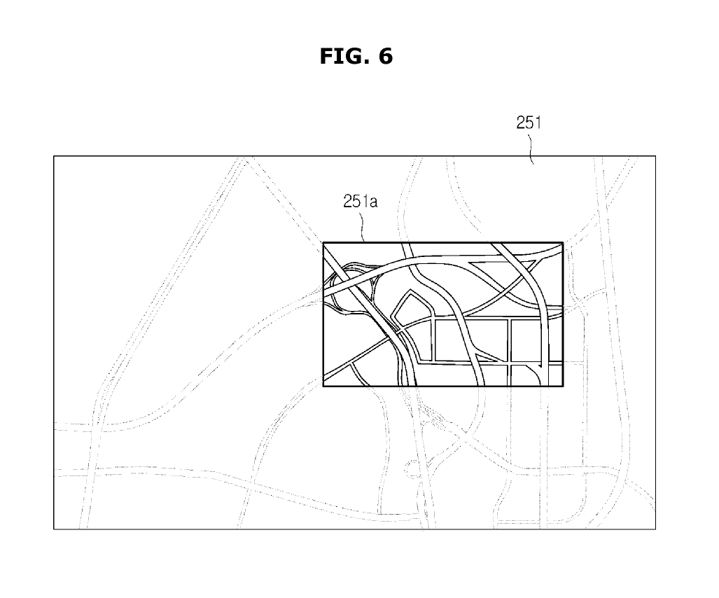

FIG. 6 illustrates a captured screen 251a of a navigation map.

The navigation controller 270 may capture the navigation map screen 251a as shown in FIG. 6 from navigation map information 251 stored in the map storage 240 based on the information about the center coordinates and reduced scale level, and information about the resolution in width and height of the display 230. The navigation map screen 251a is defined herein to be an area captured by the navigation controller 270 from the navigation map information 251.

Once the navigation map screen 251a is captured at the application controller's 280 request (i.e., in response to the request of the application controller), the navigation controller 270 may output a notification notifying the application controller 280 that capturing is done. Upon reception of the notification that capturing is done, the application controller 280 may receive information about the captured navigation map screen 251a from the map storage 250. The information about the captured navigation map screen 251a may be presented in a compressed form. The information about the navigation map screen 251a may include graphic data, latitudinal/longitudinal coordinate data of the navigation map screen 251a. The latitudinal/longitudinal coordinate data of the navigation map screen 251a may include top right or bottom left latitudinal/longitudinal coordinate data or bottom right or top left latitudinal/longitudinal coordinate data of the navigation map screen 251a.

Upon reception of the navigation map information from the navigation controller 270, the application controller 280 may run an application to display the traveling route of the vehicle 100 on the captured navigation map screen 251a and provide the navigation map screen 251a on the display 230. The application controller 270 may perform a process of decompressing the navigation map information received from the navigation controller 270 before displaying the traveling route data of the vehicle 100 on the navigation map screen 251a.

The application controller 280 may match the traveling route data of the vehicle 100 on the received navigation map screen 251a. The traveling route data of the vehicle 100 may be a set of GPS coordinates of the vehicle 100, more specifically, a set of corrected GPS coordinates.

The process of matching the traveling route data of the vehicle 100 on the navigation map screen 251a may be performed based on the top right latitudinal/longitudinal coordinates and bottom left latitudinal/longitudinal coordinates with respect to the center coordinates of the navigation map screen 251a, or on the top left latitudinal/longitudinal coordinates and bottom right latitudinal/longitudinal coordinates with respect to the center coordinates of the navigation map screen 251a.

In matching the traveling route data of the vehicle 100 on the navigation map screen 251a, a traveling route coordinate calculation algorithm may be applied as represented in the following equations 5 to 8:

POI Y Coordinate=Vertical Size of Content Area−(((POI Latitude−Bottom Left Latitudinal Coordinate)×Vertical Size of Content Area)/(POI Top Right Latitudinal Coordinate−Bottom Left Latitudinal Coordinate)) (5)

POI X Coordinate=Horizontal Size of Content Area−(((POI Longitude−Bottom Left Longitudinal Coordinate)×Horizontal Size of Content Area)/(POI Top Right Longitudinal Coordinate−Bottom Left Longitudinal Coordinate)) (6)

Route Longitude=(((Route Longitudex360,000)−Bottom Left Longitude)×Horizontal Size of Content Area)/(Top Right Longitude−Bottom Left Longitude) (7)

Route Latitude=Vertical Size of Content Area−(((Route Latitude×360,000)−Bottom Left Latitude)×Vertical Size of Content Area)/(Top Right Latitude−Bottom Left Latitude) (8)

Point Of Interest (POI) refers to a place of interest set by the user, Content Area refers to an area in which content is displayed on the display 230, and Route Longitude and Route Latitude refer to longitudes and latitudes of respective points that form the traveling route of the vehicle 100. Although the top right latitudinal/longitudinal coordinates and bottom left latitudinal/longitudinal coordinates with respect to the center coordinates of the navigation map screen 251a are used in this embodiment, other coordinates may be employed in other embodiments.

In such a way, traveling route coordinates of the vehicle 100 may be calculated, and the traveling route of the vehicle 100 may be matched on the navigation map 251a based on the calculated traveling route coordinates of the vehicle 100.

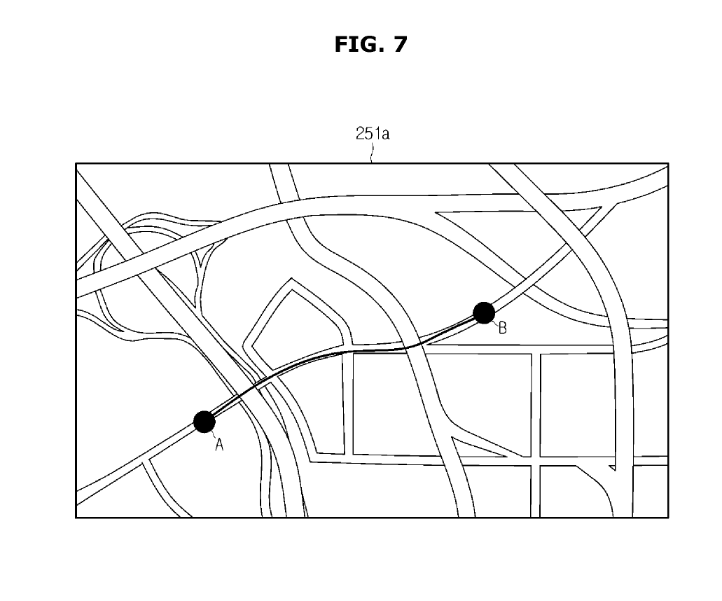

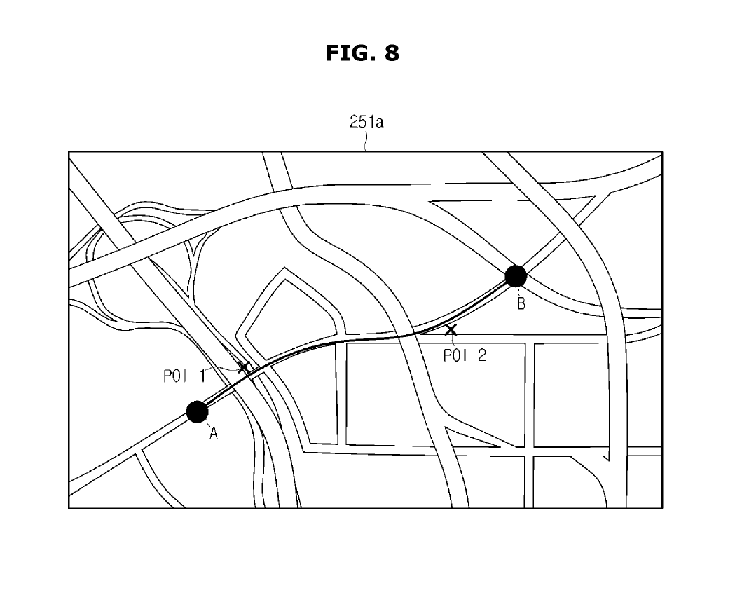

FIGS. 7 and 8 illustrate the navigation map screen 251a presented on the display 230, which display the vehicle's 100 traveling route.

As shown in FIG. 7, the application controller 180 may provide the user with the navigation map screen 251a on which the traveling route of the vehicle 100 from start point A to destination B is displayed. In an embodiment, if the user selects POI points on an application settings screen, the POI points e.g., POI1, POI2 may be additionally displayed on the way from the start point A to the destination B, as shown in FIG. 8.

The AVN device 200 and the vehicle 100 having the AVN device 200 have thus far been described. A method for controlling the vehicle 100 in accordance with an embodiment will now be described.

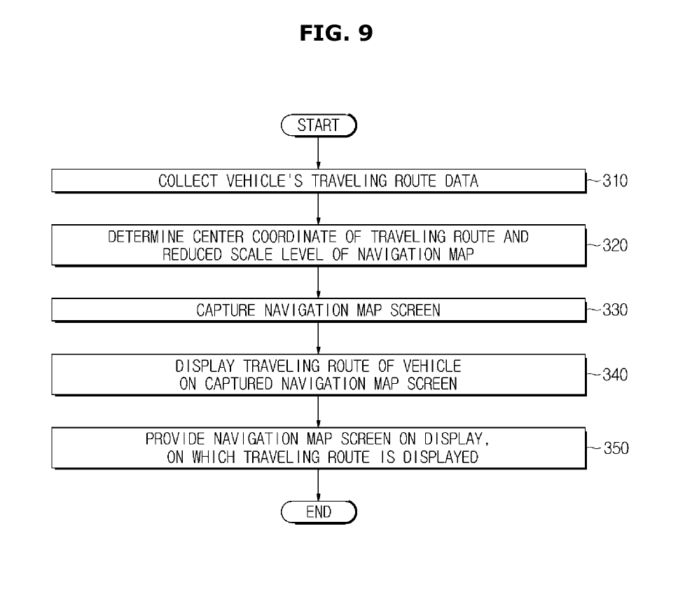

FIG. 9 is a flowchart illustrating a method for controlling the vehicle 100, according to embodiments of the present disclosure.

As shown in FIG. 9, the method for controlling the vehicle 100 includes collecting the vehicle's 100 traveling route data in operation 310, determining center coordinates of a traveling route of the vehicle 100 and a reduced scale level of a navigation map, based on the vehicle's 100 traveling route data in operation 320, capturing a navigation map screen based on the center coordinates and the reduced scale level in operation 330, displaying the traveling route of the vehicle 100 on the captured navigation map screen in operation 340, and providing the navigation map screen through the display 230, on which the traveling route is displayed in operation 350.

The method for controlling the vehicle 100 in accordance with the present disclosure includes providing a navigation screen to display a traveling route of the vehicle 100 on the display 230 of the AVN device 200, and more particularly, providing a navigation screen to display a traveling route of the vehicle 100 through an application stored in the AVN device 200 of the vehicle 100. When the navigation application runs and a command to monitor the traveling route of the vehicle 100 is input by the user, the method for controlling the vehicle 100 may be performed.

The method for controlling the vehicle 100 in accordance with an embodiment will be described below in more detail.

First, when a command to monitor a traveling route of the vehicle 100 is input by the user, the vehicle's 100 traveling route data is collected in operation 310. Collecting the vehicle's 100 traveling route data may include receiving satellite signals from remote GPS satellites through the GPS receiver equipped in the vehicle 100 and processing the satellite signals. That is, collecting the vehicle's 100 traveling route data may include obtaining GPS coordinates of the traveling route of the vehicle 100. The GPS receiver 210 may collect satellite signals at certain intervals and send the satellite signals to the navigation controller 270. The navigation controller 270 may send the GPS coordinates of the vehicle 100 received from the GPS receiver 210 to the application controller 280.

Next, center coordinates of the traveling route and a reduced scale level of a navigation map may be determined based on the vehicle's 100 traveling route data, in operation 320. More specifically, the application controller 280 may store the GPS coordinates received from the navigation controller 270, and determine center coordinates of the traveling route and a reduced scale level of a navigation map based on the GPS coordinates. Once the center coordinates of the traveling route and the reduced scale level of a navigation map is determined, the application controller 280 may send them to the navigation controller 270 and request the navigation controller 270 for navigation map data. In an embodiment, the application controller 280 may send information about resolution in width and height of the display 230 and request the navigation map data.

Having requested the navigation map data from the application controller 280, the navigation controller 270 may then capture a navigation map screen based on the center coordinates of the traveling route and the reduced scale level, in operation 330. Overlapping description related to capturing the navigation map screen based on the center coordinates of the traveling route and the reduced scale level will be omitted herein. Once the navigation map screen is captured, the navigation controller 270 may send the captured navigation map data to the application controller 280.

The application controller 280 may receive the navigation map data from the navigation controller 270 and then display a traveling route of the vehicle 100 on the received navigation map screen, in operation 340. Displaying the traveling route of the vehicle 100 on the navigation map screen may include displaying GPS coordinates of the vehicle 100 on the navigation map screen. The traveling route of the vehicle 100 may refer to a set of GPS coordinates of the vehicle 100. In displaying the traveling route of the vehicle 100 on the navigation map screen, an algorithm to calculate traveling route coordinates of the vehicle 100 may be applied, and in this regard, an overlapping description with that of the aforementioned traveling route coordinate calculation algorithm will be omitted herein.

The traveling route of the vehicle 100 may then be displayed on the navigation map screen, which may be provided for the user through the display 230, in operation 350. The navigation map screen may provide information about POI points with the traveling route of the vehicle 100, and whether to display the POI points may be determined based on the user's settings.

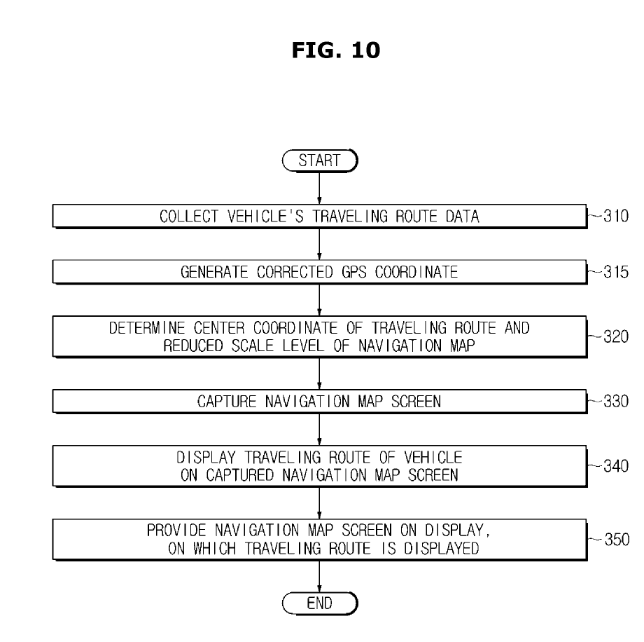

FIG. 10 is a flowchart illustrating a method for controlling the vehicle 100, according to embodiments of the present disclosure.

As shown in FIG. 10, the method for controlling the vehicle 100 includes collecting the vehicle's 100 traveling route data in operation 310, generating corrected GPS coordinates in operation 315, determining center coordinates of a traveling route and a reduced scale level of a navigation map, based on the vehicle's 100 traveling route data in operation 320, capturing a navigation map screen based on the center coordinates and the reduced scale level in operation 330, displaying the traveling route of the vehicle 100 on the captured navigation map screen in operation 340, and providing the navigation map screen through the display 230, on which the traveling route is displayed in operation 350. The method for controlling the vehicle 100 in this embodiment is different from the method of the embodiment of FIG. 9 in that it further includes generating corrected GPS coordinates, and the difference will be focused in the following description.

Traveling route coordinates of the vehicle 100 may typically have a certain margin of error due to errors in reception of the GPS signals or errors in calculation processes. Accordingly, the coordinates of the traveling route of the vehicle 100 may be matched on somewhere other than the road, e.g., river, lake, field, sidewalk, etc. Thus, the method for controlling the vehicle 100 in the embodiment may further include correcting GPS coordinates of the vehicle 100 received through the GPS receiver 210.

GPS coordinates of the vehicle 100 received by the GPS receiver 210 may be sent to the navigation controller 270. The navigation controller 270 may generate corrected GPS coordinates by matching the GPS coordinates of the vehicle 100 received from the GPS receiver 210 on a pre-stored navigation map.

The navigation controller 270 may correct the traveling route of the vehicle 100 by taking into account the form of the road, a past traveling route, traveling pattern, etc., of the vehicle 100 based on the information about the navigation map. For example, the navigation controller 270 may generate corrected GPS coordinates by matching the GPS coordinates of the vehicle 100 with roads of the navigation map, and the overlapping description with the aforementioned process will be omitted herein.

It should be understood that the steps shown in FIGS. 9 and 10 are merely examples for illustration, and certain steps may be included or excluded as desired. Further, while a particular order of the steps is shown, this ordering is merely illustrative, and any suitable arrangement of the steps may be utilized without departing from the scope of the embodiments herein. Moreover, while the procedures shown in FIGS. 9 and 10 are described separately, certain steps from each procedure may be incorporated into each other procedure, and the procedures are not meant to be mutually exclusive.

Accordingly, in view of the above embodiments of the AVN device, vehicle having the same, and method for controlling the vehicle, time and amount of information to be spent on displaying the vehicle's traveling route may be reduced by presenting the traveling route using map information contained in the AVN device. Furthermore, using the map information may help to cut down on communications fees charged for downloading a navigation map from a server.

Several embodiments have been described, but a person of ordinary skill in the art will understand and appreciate that various modifications can be made without departing the scope of the present disclosure. Thus, it will be apparent to those ordinary skilled in the art that the true scope of technical protection is only defined by the following claims.

What is claimed is:

1. An Audio-Video-Navigation (AVN) device comprising:
a Global Positioning System (GPS) receiver obtaining traveling route data of a vehicle;
a storage storing information about a navigation map;
a navigation controller capturing a navigation map screen of the navigation map; and
an application controller displaying a traveling route of the vehicle, based on the traveling route data, on the captured navigation map screen and executing an application to provide the navigation map screen on a display,
wherein the navigation controller captures the navigation map screen in response to a request of the application controller.

2. The AVN device of claim 1, wherein
the GPS receiver obtains GPS coordinates of the traveling route, and
the navigation controller generates corrected GPS coordinates by matching the GPS coordinates with the information about the navigation map.

3. The AVN device of claim 2, wherein the navigation controller generates corrected the GPS coordinates by further matching the GPS coordinates with information about roads on the navigation map.

4. The AVN device of claim 2, wherein the application controller displays the corrected GPS coordinates on the captured navigation map screen.

5. The AVN device of claim 1, wherein the application controller determines center coordinates of the traveling route and a reduced scale level of the navigation map, based on the traveling route data.

6. The AVN device of claim 5, wherein the navigation controller receives the center coordinates and the reduced scale level from the application controller and captures the navigation map screen based on the received center coordinates and reduced scale level.

7. A vehicle comprising:
a Global Positioning System (GPS) receiver obtaining a traveling route data of a vehicle;
a storage storing information about a navigation map;
a navigation controller capturing a navigation map screen of the navigation map; and
an application controller displaying a traveling route of the vehicle, based on the traveling route data, on the captured navigation map screen and executing an application to provide the navigation map screen on a display,
wherein the navigation controller captures the navigation map screen in response to a request of the application controller.

8. The vehicle of claim 7, wherein
the GPS receiver obtains GPS coordinates of the traveling route, and
the navigation controller generates corrected GPS coordinates by matching the GPS coordinates with the information about the navigation map.

9. The vehicle of claim 8, wherein the navigation controller generates the corrected GPS coordinates by further matching the GPS coordinates with roads on the navigation map.

10. The vehicle of claim 8, wherein the application controller displays the corrected GPS coordinates on the captured navigation map screen.

11. The vehicle of claim 7, wherein the application controller determines center coordinates of the traveling route and a reduced scale level of the navigation map, based on the traveling route data.

12. The vehicle of claim 11, wherein the navigation controller receives the center coordinates and the reduced scale level from the application controller and captures the navigation map screen based on the received center coordinates and reduced scale level.

13. A method for controlling a vehicle, the method comprising:
collecting traveling route data of the vehicle;
determining center coordinates of a traveling route of the vehicle and a reduced scale level of a navigation map, based on the traveling route data;
capturing a navigation map screen of the navigation map based on the center coordinates and the reduced scale level; and
displaying the traveling route on the captured navigation map screen.

14. The method of claim 13, wherein the collecting of the traveling route data comprises:
obtaining Global Positioning System (GPS) coordinates of the traveling route.

15. The method of claim 13, further comprising:
generating corrected GPS coordinates by matching the GPS coordinates with a pre-stored navigation map.

16. The method of claim 15, further comprising:
generating the corrected GPS coordinates by further matching the GPS coordinates with roads on the navigation map.

17. The method of claim 16, wherein the displaying of the traveling route comprises:
displaying the corrected GPS coordinates on the captured navigation map screen.
